(19) United States
(12) Patent Application Publication
(10) Pub. No.: US 2003/0056111 A1
(43) Pub. Date: Mar. 20, 2003

(54) Dynamically variable security protocol

(76) Inventor: John P. Brizek, Placerville, CA (US)

Correspondence Address: Timothy N. Trop, TROP, PRUNER & HU, P.C., STE 100, 8554 KATY FWY, HOUSTON, TX, 77024-1805, US

(21) Appl. No.: 09/956,210

(22) Filed: Sep. 19, 2001

(51) Int. Cl. H04L 9/00

(52) U.S. Cl. 713/200

(57) ABSTRACT

An electronic transaction may be implemented in a fashion that allows the security burden to be adjustably set based on the nature of the transaction. By receiving information about the type of transaction, a system may implement a variable security protocol. For example, the higher the value of the transaction, the greater the security protocol that may be implemented. Of course in such case, the higher security protocol may result in greater overhead or burden to the users. In other cases when the nature of the transaction permits, a lower security burden may be applied.

### BACKGROUND

This invention relates generally to security protocols for electronic systems.

Electronic systems may communicate with one another, providing information and services over wired and wireless networks. In many cases, there is a need for security in such communications. As one example, confidential information may be provided over the network between two communicating entities. As another example, payment information may be provided, which, if intercepted, could be used to defraud one of the two entities. Likewise, in a number of business transactions, it is essential to be sure that the parties that are dealing with one another actually know the identities of the party with whom they are dealing.

For all these reasons, security may be provided in connection with a wide range of electronic communications. One example of such security is an authentication protocol, which enables one user to get information about the identity of another user. Authentication is a process by which a system validates a user's identity, such as the user's logon information. The user's name and other information may be compared against an authorized list and if the system detects a match, access to the system may be granted to the extent specified in the permission list for that user. Many authentication systems are controlled by logon passwords.

Encryption is a process of encoding data to prevent unauthorized access especially during transmission. Encryption may be based on a key that is essential for decoding. An encryption key is a sequence of data that is used to encrypt other data and that consequently must be used for the data's decryption.

Still another digital security technique is the use of digital signatures. A digital signature is a personal authentication method based on encryption and secret authorization codes used for signing electronic documents. In some cases, digital signatures, being legally binding, may involve hardware security regardless of the value of the transaction being processed.

Generally, certain types of electronic transactions have predefined or fixed security protocols. A given type of protocol, generally involves a predetermined type of security, be it digital signature, encryption, authentication or some combination of these. Moreover, the burdensomeness of the security protocols may be fixed as well. Some cases may require a fingerprint input, a password input, a second password input alike, while other transactions or communications may simply involve a simple password.

Whatever the security protocol, it is generally predetermined and fixed. Thus, in some cases, relatively small value transactions must proceed with heightened security protocols designed for very high value transactions. This frustrates the user's ability to undertake routine transactions. In general, to facilitate the completion of a large variety of transactions, the highest possible security protocol may be necessitated in all cases.

Thus, there is a need to enable transactions of a variety of different values and types to be initiated using the same electronic systems.

### BRIEF DESCRIPTION OF THE DRAWINGS

FIG. 1 is a schematic depiction of a system in accordance with one embodiment of the present invention;

FIG. 2 is a flow chart for software in accordance with one embodiment of the present invention; and

FIG. 3 is a flow chart for additional software in accordance with one embodiment of the present invention.

### DETAILED DESCRIPTION

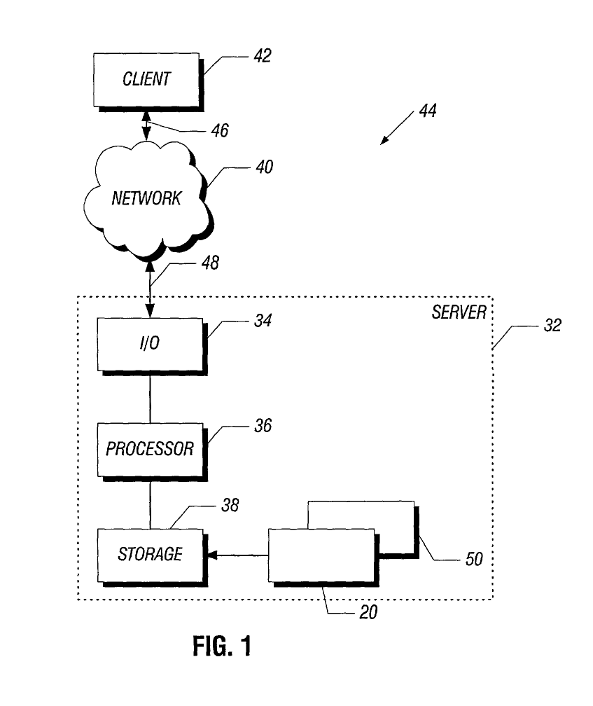

Referring to FIG. 1, a system 44 enables communications between a server 32 and a client 42. While one embodiment is described with a server/client architecture, any other communication architectures may be utilized, including peer-to-peer, multicast and broadcast type systems to mention a few examples.

The server 32 may communicate with the client 42 over a network 40. Communications to and from the network may be via links 46 and 48. The links 46 and 48 may be wired or wireless links. They may be radio frequency links or infrared links to mention a few examples.

The network 40 may be a computer or telephone network to mention a few examples. Computer networks include the Internet, local area networks, and metropolitan area networks to mention a few examples.

The server 32 includes a processor 36 coupled to an input/output port 34, which may provide an interface to the link 48. The processor 36 may also be coupled to storage 38, which stores software 20 and 50.

Ideally, the server 32 communicates with the client 42 to undertake a series of transactions. These transactions may include financial transactions, data transmissions and provision of services to mention a few examples. In each case, it is desirable to complete the transaction with the least amount of security overhead that is appropriate given the type and value of the transaction. Thus, a transaction involving a very large amount of money may need a relatively high security overhead while merely downloading a script may involve a relatively low security overhead.

In accordance with embodiments of the present invention, the level of the security overhead may be adjustably or variably determined in a dynamic fashion. This may be determined based on code information provided by an initiator of the transaction, or it may be deduced dynamically during the course of the transaction.

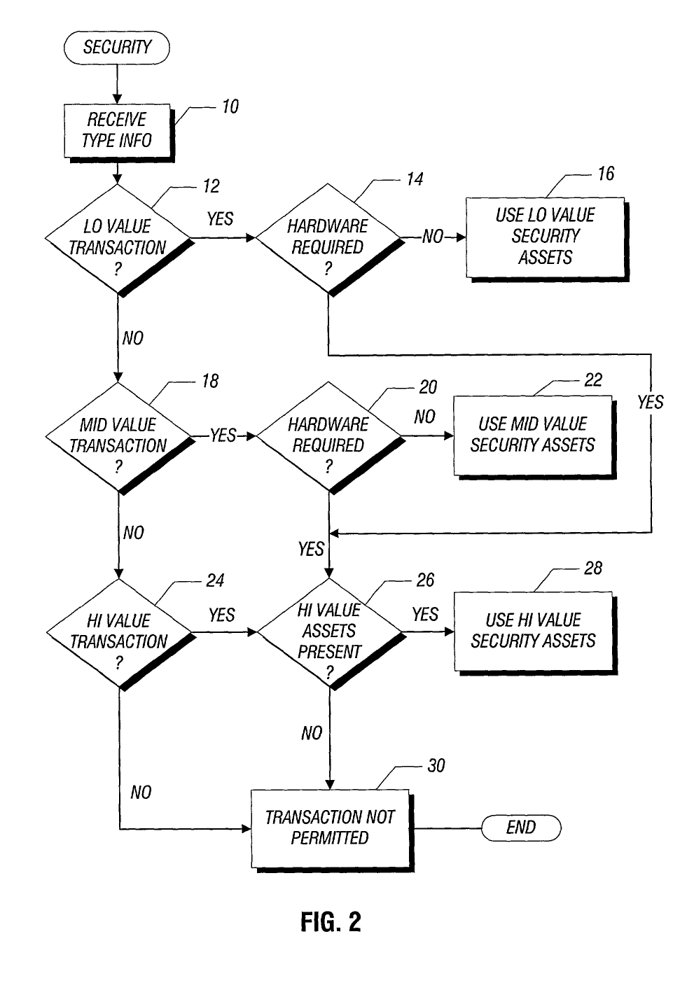

Referring to FIG. 2, the security software 20 stored in the storage 38 in FIG. 1, begins by receiving transaction type information as indicated in block 10 in accordance with one embodiment of the present invention. The type information may indicate the nature of the transaction and may be provided by the initiator. For example, the initiator of the transaction may enter information in a graphical user interface, which allows the type of the transaction to be determined. Alternatively, in another embodiment, a variety of information may be obtained from the initiator. As still another embodiment, the entity that receives the initiated transaction by the initiator may provide information. The nature of the transaction may be indicated to a degree sufficient to enable the security overhead to be dynamically adjusted.

Once the type information has been received as indicated in block 10, a check at diamond 12 determines whether or not the transaction is a low value transaction in one embodiment of the present invention. If so, a determination at diamond 14 determines whether hardware encryption is required. If not, the low value security assets may be utilized as indicated in block 16. This facilitates the execution of the transaction by reducing the security overhead. In some cases, the low value security assets may be essentially no security whatsoever and in other cases, the low value security assets may be as simple as a password. Still other security assets may be utilized in other cases. For example, in some situations, relatively low value transactions may be sufficiently valuable to require some significant level of security while still using less security overhead than would be required in other cases. If hardware is required, as determined in diamond 14, the flow iterates to another leg of the security software 20.

If a low value transaction is not involved, a check at diamond 18 determines whether a higher value or mid-value transaction is determinable based on the received type information. If so, a check at diamond 20 determines whether hardware is required. If not, a mid-value security asset may be applied as indicated in block 22. This may involve some authentication or less time consuming encryption as examples. A variety of other security assets may be applied depending on the context.

If hardware is required as determined at diamond 20, based on the type of transaction, or if hardware was required in diamond 14, a check at diamond 26 determines whether high value assets are present. If high value security assets are available, those assets may be implemented including hardware encryption as indicated in block 28. Otherwise, the transaction may not be permitted as indicated in block 30.

Finally, a check at diamond 24 determines whether the transaction is determined to be a high value transaction. If not, the transaction is not determinable and may not be permitted in one embodiment. If the transaction is determinable to be a high value transaction and high value assets are present as determined in diamond 26, the high value security assets may be applied as indicated in block 28. In such case, the security overhead or burden may be enhanced, but would be appropriate under such circumstances.

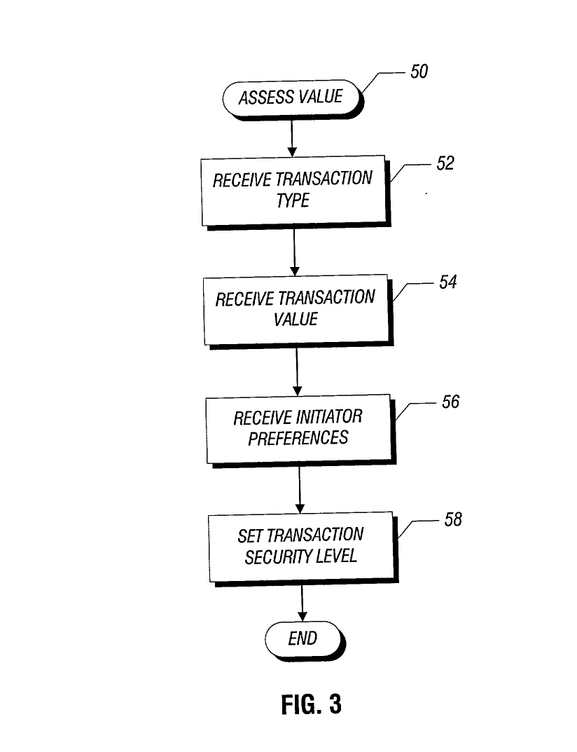

Turning finally to FIG. 3, the software 50 for assessing the value of a particular transaction may be utilized to dynamically determine the nature of the transaction. In some embodiments, the software 50 may request specific pieces of information in order to make that assessment. It may progressively ask for more information until it gets sufficient information to make the determination. In other cases, information that is naturally provided in the course of the transaction may be sufficient to make the assessment. For example, in a sales transaction based on the amount of money that is involved, or based on the type of credit that is being utilized, if any, an assessment may be made of the appropriate security asset level.

In one embodiment, transaction type information may be received as indicated in block 52. This may include whether or not it is a provision of a service, downloaded software, an online sales transaction, or the like. Information may be stored in a database about different types of transactions and their appropriate security protocols.

Next, information may be received about the transaction value as indicated in block 54. This information may be requested from the initiator or may be naturally received in the course of receiving the transaction information. In one example, the transaction value may be merely the price of the assets being purchased in an online transaction.

Next, initiator preferences may be received as indicated in block 56. In some cases, initiators may choose to undertake less security burden and in other cases, higher security burden may be desired. Thus, the initiator's own preferences may be waived in the evaluation of the appropriate security assets. Finally, the transaction security level may be assessed in block 58.

With embodiments of the present invention, the security level that is applied may be dynamically adjusted. This has advantages in enabling sufficient security while preventing overburdening a given transaction with excessive security.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
receiving information about the type of an electronic transaction; and
assessing that information to select a security level for the transaction.

2. The method of claim 1 including receiving information sufficient to determine whether the type of an electronic transaction is one of at least two predetermined transaction types.

3. The method of claim 2 including receiving information about the type of the electronic transaction sufficient to assess which of at least three transaction types the transaction falls within.

4. The method of claim 1 including determining whether hardware is required in view of the type of electronic transaction to implement security assets.

5. The method of claim 1 including determining whether an appropriate level of security asset is available.

6. The method of claim 5 including, if the appropriate level of security asset is not available, precluding the transaction from occurring.

7. The method of claim 1 including setting a security level for a transaction based on a preference received from the initiator of the transaction.

8. The method of claim 1 including setting the security level of a transaction based at least in part on information about the value of the transaction.

9. The method of claim 1 including setting the transaction security level based at least in part on information about the type of transaction.

10. The method of claim 1 including basing the level of security for a transaction at least in part on information about an initiator's security preference.

11. An article comprising a medium storing instructions that enable a processor-based system to:
receive information about the type of an electronic transaction; and
assess that information to select a security level for the transaction.

12. The article of claim 11 further storing instructions that enable the processor-based system to receive information sufficient to determine whether the type of an electronic transaction is one of at least two predetermined transaction types.

13. The article of claim 12 further storing instructions that enable the processor-based system to receive information about the type of the electronic transaction sufficient to assess which of at least three transaction types the transaction falls within.

14. The article of claim 11 further storing instructions that enable the processor-based system to determine whether hardware is required, in view of the type of electronic transaction, to implement a security asset.

15. The article of claim 11 further storing instructions that enable the processor-based system to determine whether an appropriate level of security asset is available.

16. The article of claim 15 further storing instructions that enable the processor-based system to preclude the transaction from occurring if the appropriate level of a security asset is not available.

17. The article of claim 11 further storing instructions that enable the processor-based system to set a security level for a transaction based on a preference received from the initiator of the transaction.

18. The article of claim 11 further storing instructions that enable the processor-based system to set a security level of a transaction based on information about the value of the transaction.

19. The article of claim 11 further storing instructions that enable the processor-based system to set the transaction security level based on information about the type of transaction.

20. The article of claim 11 further storing instructions that enable the processor-based system to base the level of security for a transaction, at least in part, on information about an initiator's security preference.

21. A system comprising:
a processor; and
a storage coupled to said processor, said storage storing instructions that enable the processor to receive information about the type of an electronic transaction and assess that information to select a security level for the transaction.

22. The system of claim 21 wherein said system is a telephone.

23. The system of claim 21 wherein said system is a cellular telephone.

24. The system of claim 21 wherein said storage stores instructions that enable the processor to receive information sufficient to determine whether the type of an electronic transaction is one of at least two predetermined transaction types.

25. The system of claim 21 wherein said storage stores instructions that enable the processor to determine whether hardware is required, in view of the type of electronic transaction, to implement a security asset.

26. The system of claim 21 wherein said storage stores instructions that enable the processor to set a security level for a transaction based on a preference received from the initiator of the transaction.

27. The system of claim 21 wherein said storage stores instructions that enable the processor to set a security level of a transaction based on information about the value of the transaction.

28. The system of claim 21 wherein said storage stores instructions that enable the processor to set the transaction security level based on information about the type of transaction.

29. The system of claim 21 wherein said storage stores instructions that enable the processor to base the level of security for a transaction, at least in part, on information about the initiator's security preference.

30. The system of claim 21 including an interface to interface said system to a network.
